(19) United States
(12) Patent Application Publication
(10) Pub. No.: US 2010/0026693 A1
(43) Pub. Date: Feb. 4, 2010

(54) DISPLAY DEVICE AND METHOD FOR UPDATING DATA IN DISPLAY DEVICE

(76) Inventors: Yu-Jin KIM, Gyoungsangbuk-do (KR); Su-Yeon Cho, Gyoungsangbuk-do (KR)

Correspondence Address: BIRCH STEWART KOLASCH & BIRCH, PO BOX 747, FALLS CHURCH, VA, 22040-0747, US

(21) Appl. No.: 12/443,132

(22) PCT Filed: Apr. 2, 2008
(86) PCT No.: PCT/KR2008/001845

§ 371 Date: Mar. 26, 2009

(30) Foreign Application Priority Data
Apr. 13, 2007 (KR) 1020070036311

(51) Int. Cl. G09G 5/39; G06F 12/00

(52) U.S. Cl. 345/531; 711/115; 711/E12.001

(57) ABSTRACT

Provided is an image display device. The image display device includes an interface, a memory, a controller, and a display unit. The interface supports communication with an external storage medium, and the memory stores data transmitted through the interface. The controller compares attribute information of data stored in the memory with that of data stored in the external storage medium when the external storage medium is connected through the interface and controls changing of a data name of data stored in the memory or a data name of data stored in the external storage medium depending on whether the attribute information is identical. The display unit displays whether a data name is changed in response to a control signal from the controller.

### TECHNICAL FIELD

The present disclosure relates to an image display device, and more particularly, to a method for updating data stored in an image display device and a device thereof.

### BACKGROUND ART

An image display device is a device for displaying an image. Representative examples of the image display device include a television and a monitor. Particularly, recently, an image display device includes at least one internal memory therein to realize a function of storing broadcasting signals including various images and voices received to the image display device according to a request from a user, or downloading/uploading image data from an external storage medium to the memory and vice versa.

Therefore, the user can view again the stored image data at a desired time point.

FIG. 1 is a flowchart of an operation of storing and updating data according to a related art. FIG. 1 explains an operation of downloading data from an external memory connected to an image display device.

A controller of the image display device judges (S102) whether the external memory is connected through an interface during a standby mode (S100).

When connection of the external memory storing predetermined data is detected, the controller reads the data stored in the external memory and allows the read data to be displayed through a display unit (S104).

Also, when data to be downloaded to the internal memory of the image display device is selected from the displayed data by the user, the controller controls data stored in the external memory to be downloaded to the internal memory (S106).

However, according to a related art, in the case where data stored in the external memory are moved or copied to the internal memory of the image display device, moving/coping operation has been performed unconditionally without discrimination of the attribute of data and a filename.

### DISCLOSURE OF INVENTION

### Technical Problem

According to a related art image display device, in the case where data stored in a first memory are downloaded to a second memory, the downloading operation has been performed unconditionally without judgment as to whether the same data are downloaded.

Also, in the case where a data name corresponding to data of data stored in the first memory to be downloaded exist in the second memory, the data is regarded as the same data and a download operation may not be performed even when contents of the data are different.

Therefore, data can be recognized as a different file because their data names are different from each other even when the data having the substantially the same contents exist in an internal memory inside a related art image display device or an external memory. Accordingly, the storage space of the memory is unnecessarily used.

Also, in the case where a user intends to change a name of data stored in the internal memory of the image display device, the user can change the name by manipulating a remote controller. However, as the changing of the title has been performed through repeated input of the direction keys of the remote controller, there has been a considerably difficulty in changing a desired data name.

### Technical Solution

In one embodiment, an image display device includes: an interface being configured to connected an external storage medium; a memory storing data transmitted through the interface; a controller comparing attribute information of data stored in the memory with that of data stored in the external storage medium when the external storage medium is connected through the interface; and controlling changing of a data name of data stored in the memory or a data name of data stored in the external storage medium depending on whether the attribute information is identical; and a display unit displaying whether a data name is changed in response to a control signal from the controller.

In another embodiment, a method for updating data in an image display device includes: connecting an external storage medium to the image display device; comparing attribute information of data stored in a memory inside the image display device with attribute information of data stored in the external storage medium; and changing a data name of data stored in the memory or a data name of data stored in the external storage medium depending on whether the attribute information is identical.

The details of one or more embodiments are set forth in the accompanying drawings and the description below. Other features will be apparent from the description and drawings, and from the claims.

### ADVANTAGEOUS EFFECTS

The present disclosure compares attribute information of data, without being limited to the name of already stored data in case of uploading/downloading the data to/from a plurality of memories, thereby allowing upload/download operations of the data to be performed swiftly and accurately.

Also, when the name of data stored in one memory is changed by a user or arbitrarily during uploading/downloading operations of the data, the attribute information of the data are compared, so that the changed data name can be easily applied to the data to be uploaded/downloaded.

### BRIEF DESCRIPTION OF THE DRAWINGS

FIG. 1 is a flowchart illustrating an operation of updating data in a related art image display device.

FIG. 2 is a block diagram of an image display device according to an embodiment.

FIG. 3 is a flowchart illustrating an operation of updating data according to an embodiment.

FIG. 4 is a view of a data structure according to an embodiment.

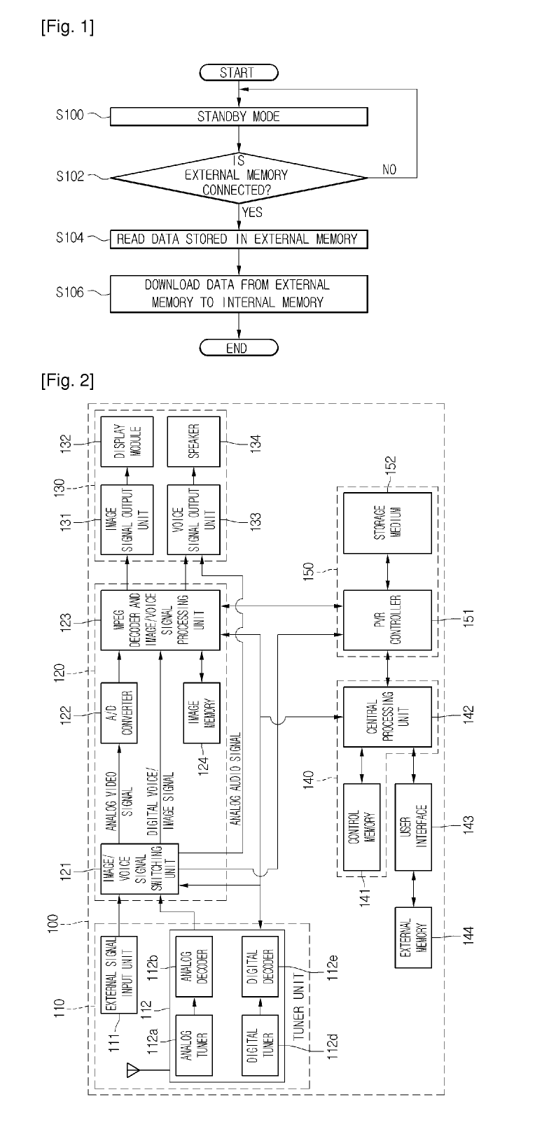

### MODE FOR THE INVENTION

Reference will now be made in detail to the embodiments of the present disclosure, examples of which are illustrated in the accompanying drawings.

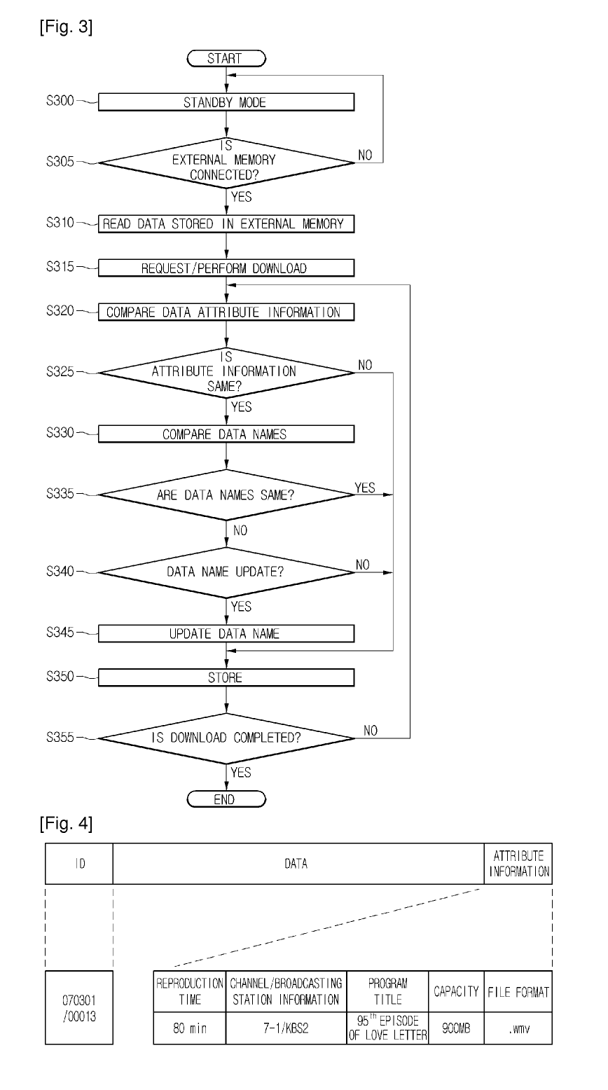

FIG. 2 is a block diagram of an image display device according to an embodiment, FIG. 3 is a flowchart illustrating an operation of updating data according to an embodiment, and FIG. 4 is a view of a data structure according to an embodiment.

Referring to FIG. 2, an image display device 100 can include a receiver 110, a processor 120, an output unit 130, a controller 140, and a user interface 143, and can further include a storage unit 150 if necessary.

The receiver 110 includes an external signal input unit 111 and a tuner unit 112. The processor 120 includes an image/voice signal switching unit 121, an analog-to-digital (A/D) converter 122, a motion picture experts group (MPEG) decoder and image/voice signal processing unit 123, and an image memory 124.

Also, the output unit 130 includes an image signal output unit 131, a display module 132, a voice signal output unit 133, and a speaker 134. The controller 140 can include a central processing unit 142,and a personal video recorder (PVR) controller 151, and a storage medium 152.

The external signal input unit 111 receives external signals received from external devices such as a digital versatile disk (DVD), a set top box, and a camcorder to provide the received signals to the image/voice signal switching unit 121.

The tuner unit 112 tunes at least one channel in response to a control signal of the central processing unit 142, and decodes/separates image/voice/data signals received through the tuned channel to provide them to the image/voice signal switching unit 121.

Also, the data signal includes electronic program guide (EPG) information including a start time and an end time of a broadcast program broadcasted through each channel.

The data signal can be deciphered as data information by a decoding operation. Program information, which is at least a portion of the data information, is delivered to the central processing unit 142 directly/indirectly. The central processing unit can explore another channel through which the same contents as contents broadcasted through a current channel using the program information.

As described above, in data use operation, another channel is explored using the data information.

The tuner unit 112 can include an analog tuner 112a receiving analog signals, a digital tuner 112d receiving digital signals, an analog decoder 112b decoding analog signals, and a digital decoder 112e decoding digital signals.

The image/voice signal switching unit 121 selects at least one channel from channels provided by the external signal input unit 111 and the tuner unit 112, separates video/voice signals of the selected channel if necessary, and then provides the separated signals to the MPEG decoder and image/voice signal processing unit 123.

The image/voice signal switching unit 121 can include a demultiplexer that can separate image/voice/data signals.

When a signal selected by the image/voice signal switching unit 121 is an analog signal, an image signal and a voice signal of the analog signal are separated, and then the analog image signal is converted into a digital image signal by the A/D converter 122, and provided to the MPEG decoder and image/voice signal processing unit 123.

Also, a corresponding analog voice signal can be provided to the voice signal output unit 133. When a signal selected by the image/voice signal switching unit 121 is a digital signal, both an image signal and a voice signal of the digital signal can be provided to the MPEG decoder and image/voice signal processing unit 123.

The MPEG decoder and image/voice signal processing unit 123 recovers and processes an image/voice stream of output signals from the image/voice signal switching unit 121 into image/voice data. The processed image signal is provided to the image signal output unit 131, and the processed voice signal is provided to the voice signal output unit 133.

Also, the MPEG decoder and image/voice signal processing unit 123 can mix on-screen-display (OSD) data provided by the central processing unit 142 and a recovered and processed image signal.

Particularly, the MPEG decoder and image/voice signal processing unit 123 displays images of collected channels on a screen using a predetermined method when a manual method is determined in channel selection method determination operation.

The collected channels and a currently selected channel are displayed in a small size inside the screen S in displaying images of the collected channels on the screen S. A specific channel of the channels displayed in the small size can be selected in response to a control signal delivered through a user interface 143, and a corresponding image can be displayed on the screen. This display method is called a selective display method.

The image memory 124 provides a memory area required when the MPEG decoder and image/voice signal processing unit 123 decodes and performs a signal process. Particularly, the image memory 124 and a control memory 141 are used for comparing sameness in contents of two or more channels when an image comparison operation of broadcasting the same contents is performed.

The image signal output unit 131 processes an image signal in a form such that the image signal output from the MPEG decoder and image/voice signal processing unit 123 can be output through the display module 132. The voice signal output unit 133 processes a voice signal in a form such that the voice signal output from the MPEG decoder and image/voice signal processing unit 123 can be output through the speaker 134.

The user interface 143 provides an interface for an external memory according to an embodiment, and the controller 140 uploads or downloads data including additional information (filename, file size, generation data, etc) from the external memory to the control memory 141 or the storage medium 152.

The control memory 141 stores information input by a user or data generated and managed by the central processing unit 142.

Particularly, the central processing unit 142 of the controller 140 checks the attribute information of data and a data name when data is moved, copied, or downloaded/uploaded between the external memory and the internal memory to control the data to be downloaded/uploaded depending on whether the attribute information of the data is the same.

Also, the controller 140 updates and stores a data name according to a request of the user, generates unique identification (ID) corresponding to each data at a time point at which the data is generated, and inserts the unique ID into the attribute information or can provide the unique ID as separate header information of the data.

Also, the central processing unit 142 inside the controller 140 controls the tuner unit 112, the image/voice signal switching unit 121, and the MPEG decoder and image/voice signal processing unit 123, and can be designed and connected to control other elements of the image display device 100 if necessary.

The control memory 141 stores information input by a user or data generated and managed by the central processing unit 142.

The PVR controller 151 can store image/voice signals output from the image/voice signal switching unit 121 and/or the MPEG decoder and image/voice signal processing unit 123 in the storage medium 152 in response to a control of the central processing unit 142. The PVR controller 151 can read image/voice signals stored in the storage medium 152 to provide the same to the MPEG decoder and image/voice signal processing unit 123.

The image display device 100 according to an embodiment can include the user interface 143 that can be connected to an external memory 144. Also, though description of the present disclosure is limited to the image display device 100, the present disclosure can be applied to a device having at least one memory or a device that can be connected to the image display device through an external interface and thus connected to the external memory besides the image display device.

The operation of the image display device using an operation of updating image data will be described below in detail with reference to FIGS. 3 and 4 according to an embodiment.

In an embodiment, an external memory connected with the image display device through the external interface, and storing data to be copied to the storage unit of the image display device is defined as a first memory.

Also, an internal memory copying or updating data stored in the first memory to store the same, and provided inside the image display device is defined as a second memory.

The first memory and the second memory can be exchanged with each other, and are not limited to the inner and external memories. In the case where there exist a plurality of internal memories, the plurality of internal memories can be defined as the first memory and the second memory.

The controller 140 of the image display device performs a standby mode or a function performance mode performing a specific function (S300). At this point, when detecting a predetermined signal, the controller 140 judges whether the signal is a connection signal of the external memory through the external interface (S305).

When detecting connection of the external memory through the external interface as a result of the judgment, the controller 140 reads data already stored in the external memory and displays the data on a display unit (S310).

Here, when the data stored in the external memory are image data, the data can be reproduced and displayed or the attribute information (e.g., filename or construction of metal data) of the data can be displayed. However, the construction of reading and displaying the data stored in the external memory is not necessarily required. Operation S310 may not be performed depending on an embodiment.

Meanwhile, the controller 140 sequentially performs a request of download to the internal memory and a corresponding data download operation to the internal memory on entire data read and displayed from the external memory or a portion of the entire data selected by a user (S315).

Also, the controller 140 compares the attribute information of data already stored in the internal memory with the attribute information of data to be downloaded as the download is performed (S320).

Here, the attribute information of the data can be unique ID generated by the controller 140 or meta data corresponding to a relevant file/data. For example, the controller 140 compares the meta data of a file stored in the first memory of the outside with the meta data of a file stored in the second memory inside the image display device to judge whether the files are the same.

Also, referring to FIG. 4, the attribute information includes a reproduction time of broadcast data, a start time and an end time of broadcast data, a channel/broadcasting station information through which the broadcast data is broadcasted, and a program title. Also, the attribute information includes a capacity and a file format in which the broadcast data are stored in the memories.

Particularly, the header of the broadcast data can include unique ID including a generation point of the broadcast data, or download/upload point and the sequence of data generated at a specific date/point. The ID can be included in header information or the attribute information. The ID can be automatically generated by a sequence assigned to the memory in advance according to setting by a user and under control of the controller.

Therefore, when the attribute information of data to be downloaded is not the same as that of data stored already in the internal memory as a result of the comparison, the controller 140 allows a download operation same as a general data download operation to be performed (S350).

Meanwhile, when the attribute information of data to be downloaded is the same as that of data stored already in the internal memory, data names of data having the same attribute information are compared with each other (S330).

Also, when data having the same attribute information are the same in their data name, the controller 140 judges that data stored in the internal memory is the same as data to be downloaded from the external memory, and allows the data to be downloaded using the same operation as a download operation of data having different attribute information (S350).

Also, when data stored in the internal memory and data to be downloaded are the same in their attribute information but different in their data name as a result of the comparison of the data name, the controller 140 judges the data are the same data. Also, the controller 140 displays a message confirming whether to update data already stored in the internal memory using a data name of data to be downloaded from the external memory (S340). Therefore, different data names are updated using one of the data names serving as a reference name (S345).

In an embodiment, description has been made for the case where data are the same in their attribute information but different in their data name, data is updated and stored using data that is stored in the external memory and is to downloaded. However, a generation point or a change point of data included in the attribute information of data is checked, so that an updating operation can be performed using the data name of most recently changed data.

Also, the updating operation can be performed using the data name of one of data stored in the internal memory or the external memory set to serve as a reference name by a user.

According to an embodiment, the controller 140 updates data having the same attribute information as that of data already stored in the internal memory using the data name of data to be downloaded from the external memory, and stores the updated data in the internal memory (S350).

Also, the controller 140 judges whether the downloading of the data has been completed (S355). When the downloading has not been completed, data to be downloaded are sequentially downloaded according to the above-described sequence.

### INDUSTRIAL APPLICABILITY

The present disclosure is directed to data transmission between the internal memory of the image display device and an external memory, and industrial applicability thereof is confirmed.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

1. An image display device comprising:
an interface being configured to connected an external storage medium;
a memory storing data transmitted through the interface;
a controller comparing attribute information of data stored in the memory with that of data stored in the external storage medium when the external storage medium is connected through the interface, and controlling changing of a data name of data stored in the memory or a data name of data stored in the external storage medium depending on whether the attribute information is identical; and
a display unit displaying whether a data name is changed in response to a control signal from the controller.

2. The image display device according to claim 1, wherein the attribute information comprises unique identification generated by the controller.

3. The image display device according to claim 1, wherein the attribute information comprises meta data corresponding to each data.

4. The image display device according to claim 1, wherein the controller updates a data name of the data stored in the memory using a data name of recently modified data when the attribute information is the same as a result of the comparison.

5. The image display device according to claim 1, wherein the controller compares the attribute information and then changes data names of data stored in one of the memory and the external storage medium using recently modified data names.

6. The image display device according to claim 1, wherein the controller stores together the attribute information including at least one of a reproduction time of data, a program title, a capacity, a file format, and channel information when storing the data.

7. The image display device according to claim 1, wherein the controller displays a user selection menu for changing a data name of data when the attribute information of respective data is the same as a result of the comparison.

8. A method for updating data in an image display device, the method comprising:
connecting an external storage medium to the image display device;
comparing attribute information of data stored in a memory inside the image display device with attribute information of data stored in the external storage medium; and
changing a data name of data stored in the memory or a data name of data stored in the external storage medium depending on whether the attribute information is identical.

9. The method according to claim 8, wherein the attribute information comprises unique identification generated according to a generation point and a generation sequence of data.

10. The method according to claim 8, wherein the attribute information comprises meta data corresponding to each data.

11. The method according to claim 8, wherein the operation of changing the data name comprises updating the data name of the data stored in the internal memory using a data name of recently modified data when the attribute information of respective data is the same as a result of the comparison.

12. The method according to claim 8, wherein the operation of changing the data name comprises, after the comparing of the attribute information, changing data names of data stored in one of the internal memory and the external storage medium using recently modified data names.
